(19) United States
(12) Patent Application Publication
(10) Pub. No.: US 2004/0038572 A1
(43) Pub. Date: Feb. 26, 2004

(54) Safety easily operable universal adaptor

(76) Inventor: Ke-Chih Liu, Taipei (TW)

Correspondence Address: RABIN & BERDO, P.C., Suite 500, 1101 14th Street, N.W., Washington, DC, 20005, US

(21) Appl. No.: 10/226,131

(22) Filed: Aug. 23, 2002

(51) Int. Cl. H01R 29/00

(52) U.S. Cl. 439/172

(57) ABSTRACT

A safety easily operable universal adaptor which mainly disposed with a safety device and a set of shutter whereupon a control rod of the safety device is displaced toward the right and left in opposition to an up and down motion of a positioning block and then forcibly limited each plug pin to keep in position so as to enable only single set of the plug pin can be protruded outwardly; the set of shutter is disposed in the inner side of an socket of an adaptor body and then push the shutter away when a plug is inserted therein, so as to insert the socket and electrically connect to a electrically conductive plate therebetween; by virtue of this arrangement, an electrified state is formed between the plug and the plug pin.

### FIELD OF THE INVENTION

This invention relates to a safety easily operable universal adaptor, and more particularly to a current adaptor which only single set of the plug pin can be protruded outwardly and conducted electricity and which a suitable shutter is provided to the socket.

### BACKGROUND OF THE INVENTION

A conventional safety adaptor is provided for an adaptor body disposed with varied type of the socket in conformity with different countries, such as American, United Kingdom, Australian and European, and one set of varied plug pins corresponding to an outer adaptor is selected for insertion thereby making the adaptor to conduct electricity.

However, when a user uses a conventional safety easily operable universal adaptor, all they can do are correctly inserted single set of exposed plug pin without any safety device for keeping the rest plug pins from exposure. Thus, when users select a specific set of exposed plug pin to insert a corresponding outer adaptor, the rest plug pins would be exposed and occurred outwardly protrusion, and then result in getting the risk of an electric shock or short circuit.

It is therefore tried by the inventor to develop a safety easily operable universal adaptor, especially a safety easily operable universal adaptor having a safety device and a security shutter for saving the above-mentioned persecutions and drawbacks.

### SUMMARY OF THE INVENTION

Accordingly, it is a primary object of the present invention claimed herein to provide a safety easily operable universal adaptor, which is enable to achieve forcefully protection by the function of a safety device and a security shutter, so as to improve the security in use.

It is another object of the present invention to provide a safety easily operable universal adaptor, which is enable to make an inner side of an adaptor correspond with the position of each set of a plug pin in action and further dispose with a safety device displaced toward the right and left in opposition to an up and down motion of a positioning block and then forcibly limited each set of the plug pin to keep in position so as to enable only single set of the plug pin can be protruded outwardly without limitation thereby preventing the rest plug pins from exposing and getting the risk of an electric shock or short circuit.

A further object of the present invention is to provide a safety easily operable universal adaptor, wherein a set of shutter is disposed in the inner side of an socket of the adaptor and then push the shutter away so as to insert a plug into the socket and electrically connect to the electrically conductive plate; by virtue of this arrangement, an electrified state is formed in the plug and the plug pin.

### BRIEF DESCRIPTION OF THE DRAWINGS

The structure adopted by the present invention to achieve the above and other objects can be best understood by referring to the following detailed description of the preferred embodiments and the accompanying drawings, wherein

FIG. 1 is an exploded view illustrating a safety easily operable universal adaptor according to the present invention;

FIG. 2 is a part of an assembly exploded view illustrating safety easily operable universal adaptor according to the present invention;

FIG. 3 to FIG. 7 is a part of an assembly exploded view illustrating the moving of the safety device according to the present invention;

FIG. 8 and FIG. 9 show the state when the set of shutter is pushed and displaced by the plug according to the present invention;

FIG. 10 and FIG. 11 show the state when the set of shutter is completely displaced and the plug is smoothly inserted therein according to the present invention;

FIG. 12 to FIG. 15 shows the insertion state of the Australian type plug;

FIG. 16 to FIG. 19 shows the insertion state of the Europe type plug; and

FIG. 20 to FIG. 23 shows the insertion state of the American type plug.

### DETAIL DESCRIPTION OF THE REFERRED EMBODIMENTS

With references to the drawings, a safety easily operable universal adaptor according to the present invention comprises an adaptor body 1, an electrically conductive plate 2, a plurality set of plug pins 3, a safety device 4 and a set of shutter 5.

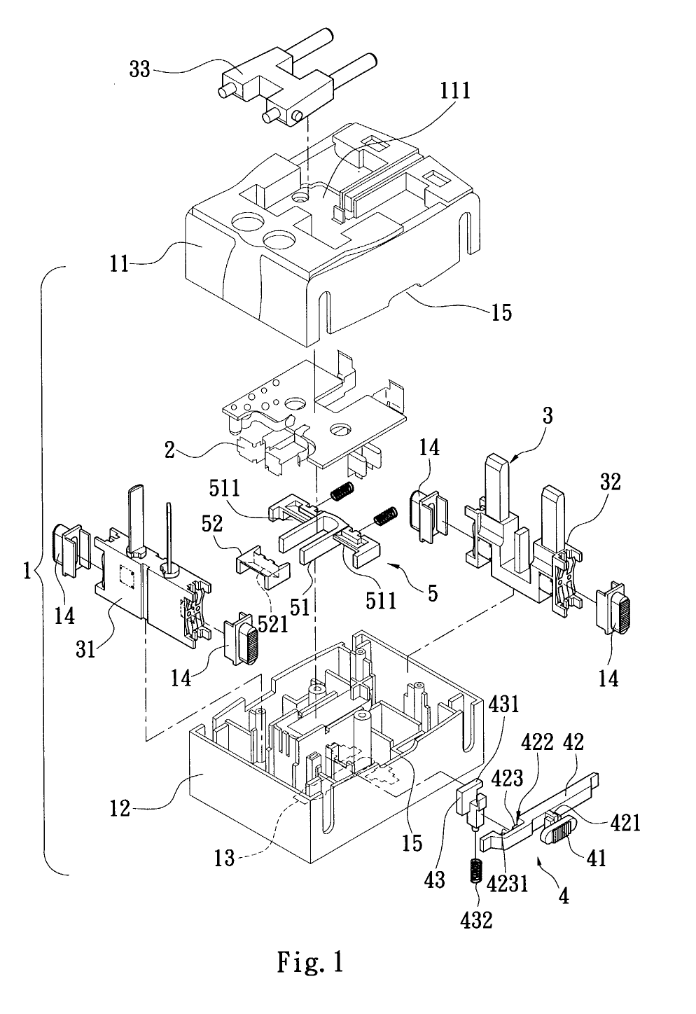

The adaptor body 1 includes an upper cover 11 and a lower cover 12 in opposition to each other, as shown in FIG. 1, an socket 13 for the insertion of a plug is provided on the surface of the lower cover 12 wherein the socket 13 is corresponded to varied plugs, such as the American type plug, the United Kingdom type plug, the Australian type plug and the Europe type plug, and without limitation. Also, two blocks are disposed in both sides of the adaptor body 1 for controlling the lengthened and shortened motion of the plug pins. A groove 111 is provided in the surface side of the upper cover 11.

The electrically conductive plate 2 is disposed in the inner side of the upper cover 11 and is corresponded to the socket 13.

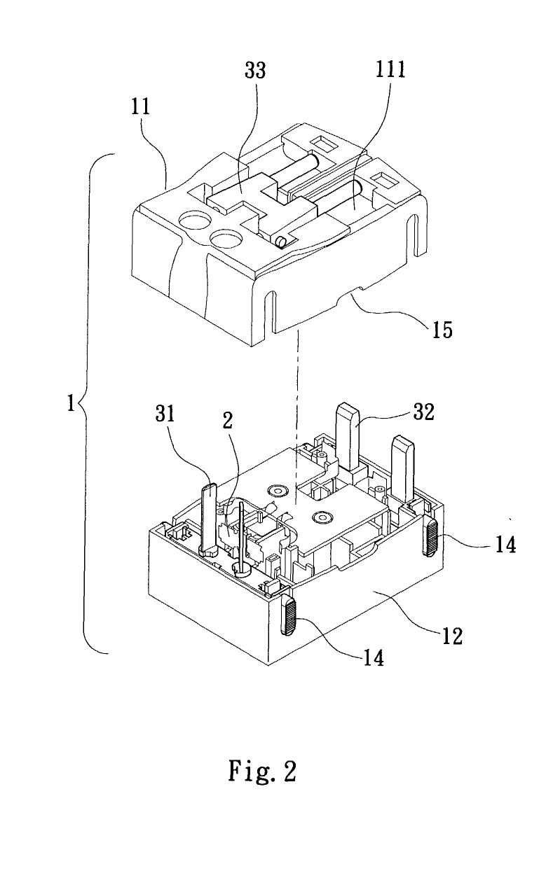

The plug pin 3 includes a first plug pin 31 for the American type plug and the Australian type plug collectively, a second plug pin 32 for the United Kingdom type plug and a third plug pin 33 for the Europe type plug. The first plug pin 31 and the second plug pin 32 are vertically accommodated in the front end and the rear end of the adaptor body 1. The third plug pin 33 is horizontally disposed in the groove 111 of the upper cover 11, as shown in FIG. 2. The first plug pin 31 and the second plug pin 32 are protruded from the surface of the upper cover 11 by the motion of the block 14 and the bottom ends thereof are capable to contact the electrically conductive plate 2. The third plug 33 is contact to the electrically conductive plate 2 in the inside of the adaptor body 1 after it is turned upward from the surface of the upper cover 11.

This invention is characterized in that the safety device 4 is formed with a push button 41, a control rod 42 and a positioning block 43. The push button 41 is accommodated in a sliding groove 15 formed on a lateral surface of the upper cover 11 and the lower cover 12. The control rod 42 is formed in a long rod shape wherein a protrusion 421 is disposed in the outer side of the rod for covering the push button 41 and a guiding groove 422 is disposed in the specific inner of the rod and a step 423 is disposed in the inner side of the rod. A smaller groove 4231 is disposed approximately in the center of the step 423. The positioning block 43 is formed as a pillar wherein a curve salient and an approximately L shaped block 431 are formed in the top end thereof respectively and a convex rod provided for a return spring 432 to insert therein is disposed in the bottom end thereof. The return spring 432 is capable to insert from the top of the guiding groove 422 through the bottom end of the positioning block 43 and the guiding groove 422 is capable of engaging into the protruded side of the positioning block 43 with the movement of the push button 41 so as to control the motion of both sides of the control rod 42. Therefore, the up and down motion of the positioning block 43 is limited by the protruded side of the positioning block 43 via the fastening of the step 423.

The set of shutter 5 supported by an elastic component and flexibly disposed in the inner side of the socket 13 includes a main shutter 51 and a secondary shutter 52. Both sides of the main shutter 51 are corresponding to the plate surface of the socket 13 and two inclined planes 511,521 are disposed on the center of the secondary shutter 52 in corresponding to the plate surface of the socket 13 respectively.

By utilizing the above-mentioned members, the control rod 42 of the safety device 4 is thus disposed in the inner side wall of the adaptor body 1 transversely and is turned in corresponding to the up and down motion of the positioning block 43 by the push button 42, so that the control rod 42 and the positioning block 43 are capable of limiting or releasing the interruption to each plug pin 3 depending on the locations thereof. By virtue of this arrangement, the adaptor may be provided with forcibly protection. Meanwhile, the set of shutter 5 is sealed in the inner side of the socket 13 and the plug 6 may only be inserted with correct way in which the position of the main shutter 51 or the secondary shutter 52 is transposed by utilizing any inclined planes 511, 521, so as to form an electrified state between the plug 6 and the protrusive plug pin 3 and prevent an improper foreign matter from being inserted into the socket 13.

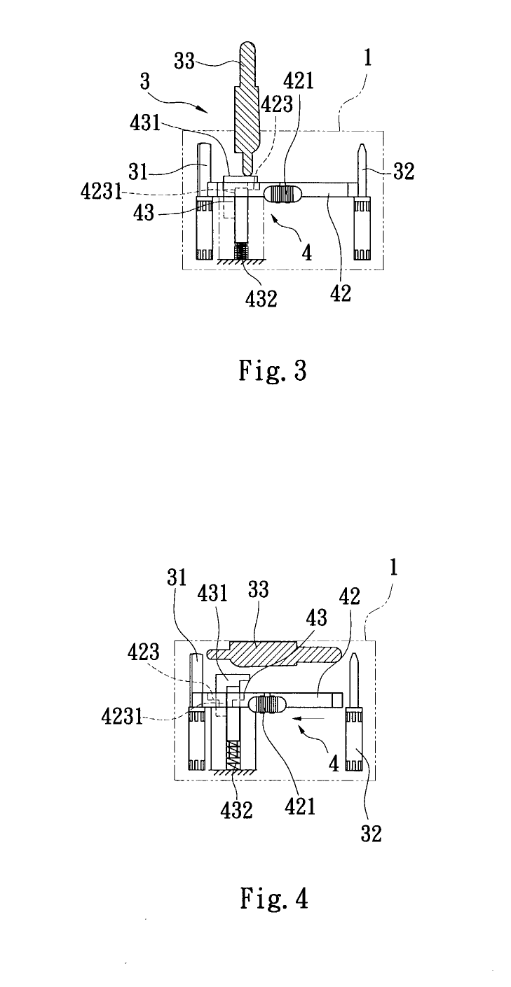

Further, the mechanism of this invention for effectively restraining the plug pin from an improper protrusion will be described as follows: First, when the control rod 42 and the position block are moved by the push button 41 and then kept in the center of the sliding groove 15 as shown in FIG. 3, because both side of the control rod 42 may only be fastened in the upper side end of the first plug pin 31 and the second plug pin 32 and the L shaped block 431 of the position block 43 located within the groove 4231 is located in the lower end of the third plug 33, the position block 43 held against by the return spring 432 is then downwardly moved into the groove 4231, so as to prevent the upwardly reversed motion of the third plug pin 33 from being interrupted by the L shaped block 431. Thus, the adaptor may be electrically connected by outwardly reversing the third plug pin 33 only.

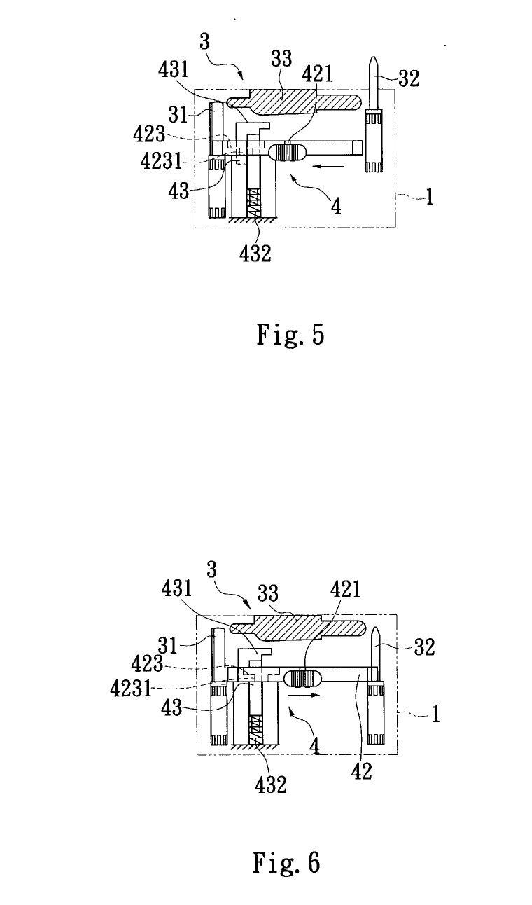

Further, when the control rod 42 and the position block 43 are moved by the push button 41 and then kept in the left side of the sliding groove 15 as shown in FIG. 3, because the left side of the control rod 42 may only be fastened in the upper side of the first plug pin 31 and limited the first plug pin 31 to protrude outwardly, the control rod 42 is displaced toward the left and the protruded side of the position block 43 located on the top of the step 423 is supported thereof. Therefore, when the third plug pin 33 is on the point of upwardly reversing, because the end of the third plug pin 33 is downwardly reversed against the limited position block 43 and the protruded side of the position block 43 held upwardly by the step 423 is unable to go down, so as to prevent the third plug pin 33 from being outwardly reversed thereof, as shown in FIG. 4. Therefore, the second plug pin 32 without being pressed by the control rod 42 is protruded outwardly by the motion of the block 14 and thus the adaptor may be electrically connected therein, as shown in FIG. 5.

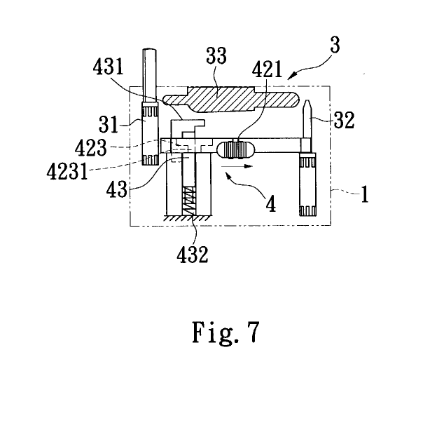

Moreover, when the control rod 42 and the position block 43 are moved by the push button 41 and then kept in the right side of the sliding groove 15 as shown in FIG. 3, making the right side of the control rod 42 be fastened in the upper side of the second plug pin 32 so as to limit the second plug pin 32 from being protruded outwardly. Therefore, when the third plug pin 33 moved toward the right by the control rod 42 is on the point of upwardly reversing, because the end of the third plug pin 33 is limited to outwardly reverse by the intercept of the L shaped block 431, as shown in FIG. 7. Thus, the first plug pin 31 is protruded outwardly by the motion of the block 14 and the adaptor may be electrically connected therein, as shown in FIG. 7.

By virtue of the above-mentioned arrangement, the control rod 42 of the safety device 4 is displaced toward the right and left in opposition to an up and down motion of a positioning block 43 and forcibly limited each plug pin to keep in position so as to enable only single set of the plug pin can be protruded outwardly without the interruption of the plug pin 3 thereby forcefully protection has been achieved and the security in use has been improved.

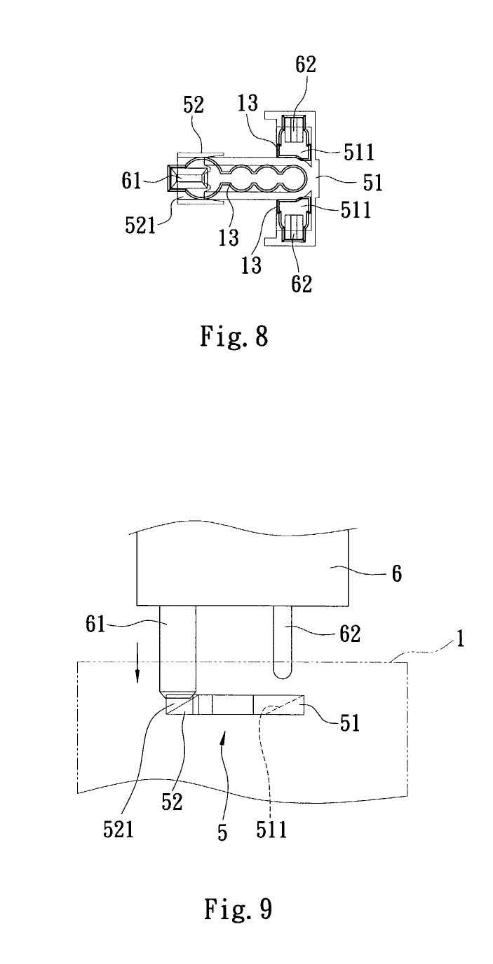

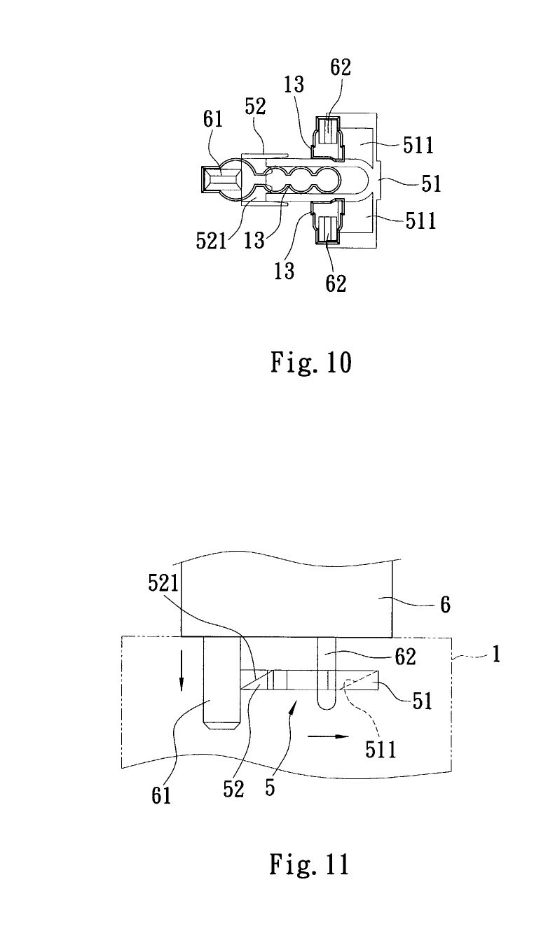

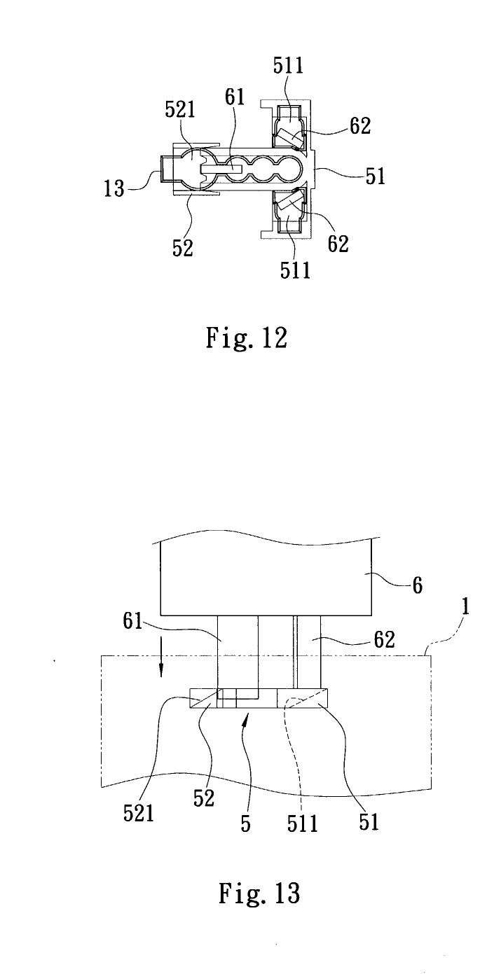

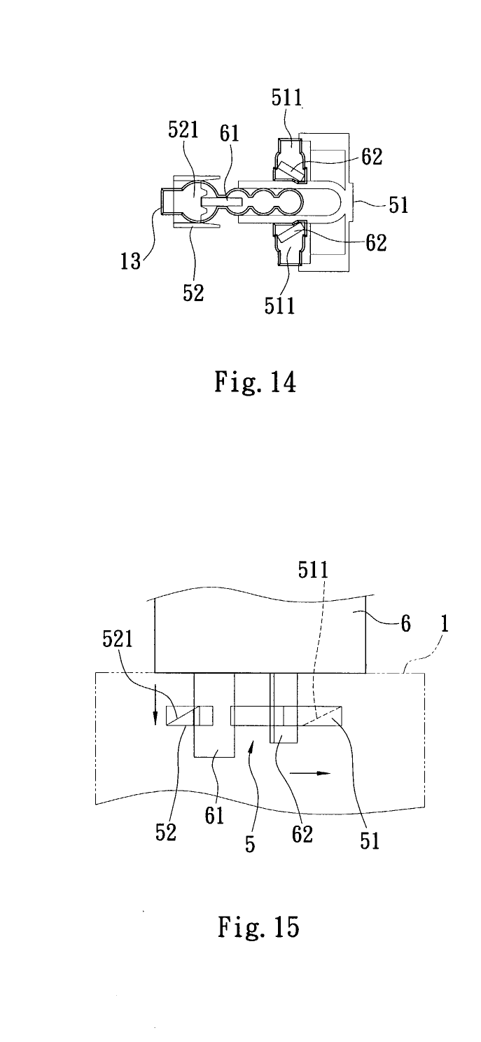

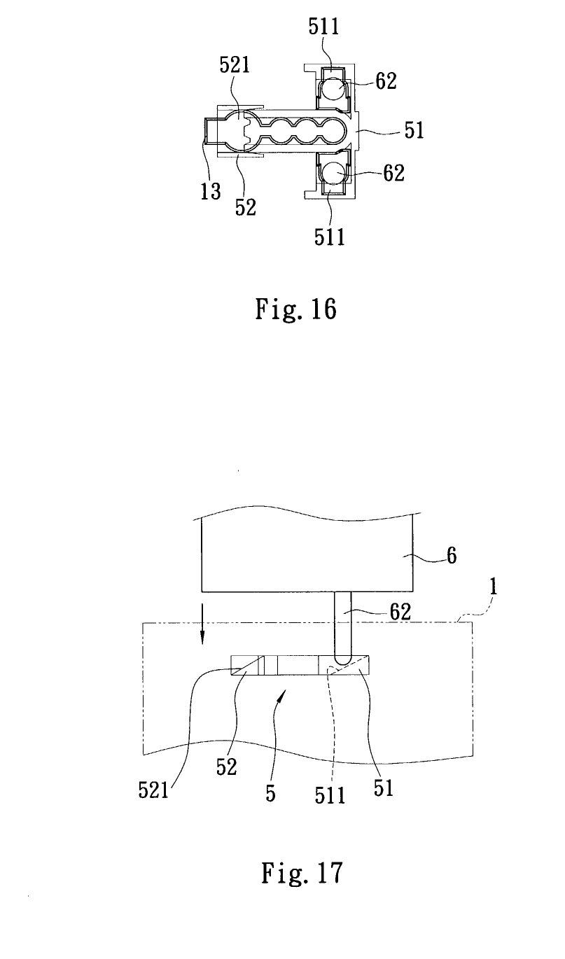

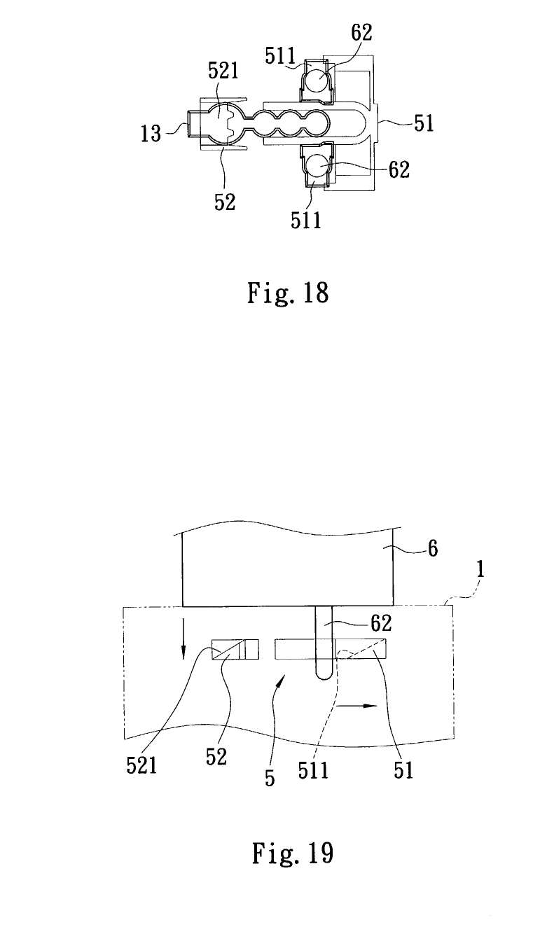

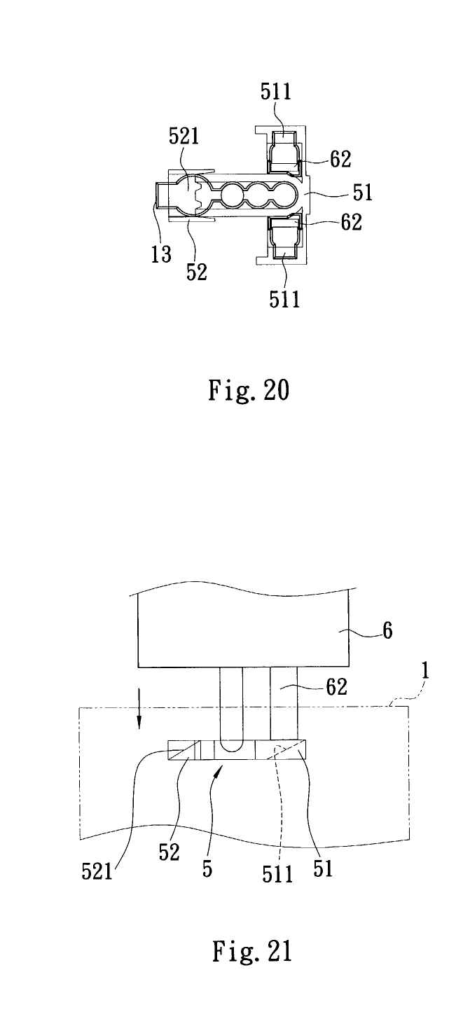

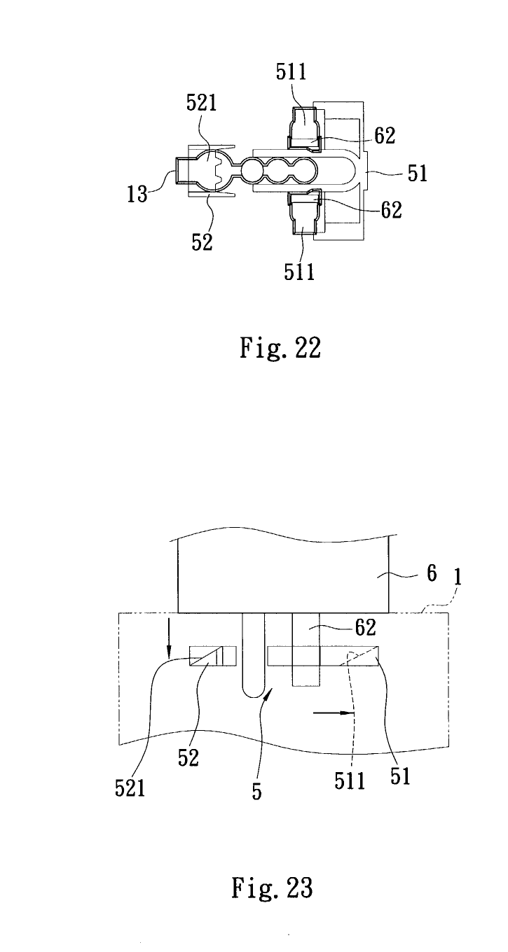

Furthermore, as shown in FIG. 8 and FIG. 9, because a grounding pin 61 longer than a conductive pin 62 is provided for the United Kingdom type plug, when the United Kingdom type plug according to the present invention is inserted through the socket 13, the inclined plane 521 is first pressed by the grounding pin 61 and then the secondary shutter 52 is displaced onward therein. Also, the main shutter 51 is moved accordingly so as to make the conductive pin 62 of the socket 13 is inserted into the electrically conductive plate 2 smoothly and an electrified state is formed between the plug 6 and the plug pin 3, as shown in FIG. 10 and FIG. 11. Similarly, as the insertion state of varied type plugs are shown in FIG. 12 to FIG. 23, two conductive pins 62 of the plug 6 are inserted into the socket 13 simultaneously and is further pushed against the main shutter 51 by two inclined planes 511, 521 of the main shutter 51, so that the plug 6 may be electrically connected therein.

What is claimed is:

1. A safety easily operable universal adaptor comprising an adaptor body, an electrically conductive plate, a plurality set of plug pins, and a safety device, wherein the adaptor body includes an upper cover and a lower cover in opposition to each other and, an socket for the insertion of a plug is provided on the surface of the lower cover and two blocks are disposed in both sides of the adaptor body for controlling the lengthened and shortened motion of the plug pins; the electrically conductive plate is disposed in the inner side of the upper cover and is corresponded to the socket; the plug pin includes a first plug pin, a second plug pin and a third plug pin, and each plug pin is capable of entering and accommodating into the adaptor body and then is protruded from the surface of the upper cover by the motion of the block; it is characterized in that the safety device is formed with a push button, a control rod and a positioning block, the push button is accommodated in a sliding groove formed on a lateral surface of the upper cover and the lower cover and the control rod is formed in a long rod shape wherein a protrusion is disposed in the outer side of the rod for covering the push button and, a guiding groove is disposed in the specific inner in which a step is disposed therein and a smaller groove is disposed approximately in the center of the step, the top end of the positioning block is formed with a curve salient and an approximately L shaped block respectively and a convex rod provided for a return spring to insert therein is disposed in the bottom end of the positioning block, so as to make the return spring be capable to insert from the top of the guiding groove through the bottom end of the positioning block and the guiding groove is engaged into the protruded side of the positioning block;
by utilizing the above-mentioned members, the control rod of the safety device is disposed in the inner side wall of the adaptor body transversely, thus the control rod is turned in corresponding to the up and down motion of the positioning block by the push button, so that the control rod and the positioning block are capable of limiting or releasing the interruption of each plug pin depending on the locations thereof and thereby the adaptor may be provided with forcibly protection.

2. The safety easily operable universal adaptor as claimed in claim 1, wherein the position block is formed as a pillar.

3. A safety easily operable universal adaptor comprising an adaptor body, a electrically conductive plate, a plurality set of plug pins and a set of shutter, wherein the adaptor body includes an upper cover and a lower cover in opposition to each other and, an socket for the insertion of a plug is provided on the surface of the lower cover and two blocks are disposed in both sides of the adaptor body for controlling the lengthened and shortened motion of the plug pins; the electrically conductive plate is disposed in the inner side of the upper cover and is corresponded to the socket; the plug pin includes a first plug pin, a second plug pin and a third plug pin, and each plug pin is capable of entering and accommodating into the adaptor body and then is protruded from the surface of the upper cover by the motion of the block; it is characterized in that the set of shutter supported by an elastic component and flexibly disposed in the inner side of the socket includes a main shutter and a secondary shutter, both side of the main shutter are corresponding to the plate surface of the socket and two inclined planes are disposed on the center of the secondary shutter in corresponding to the plate surface of the socket respectively;
by utilizing the above-mentioned members, when the grounding pin or the conductive pin of the plug is inserted into the adaptor, the position of the main shutter or the secondary shutter is transposed by utilizing any inclined planes, thus enable the plug may be inserted into the socket and electrically connected with the electrically conductive plate to electrify therebetween.

4. The safety easily operable universal adaptor as claimed in claim 1, wherein the first plug pin is capable of switching into the plug pin of the American type plug or the Australian type plug.

5. The safety easily operable universal adaptor as claimed in claim 1, wherein the second plug pin is United Kingdom type plug.

6. The safety easily operable universal adaptor as claimed in claim 1, wherein the third plug pin is Europe type plug.

7. The safety easily operable universal adaptor as claimed in claim 3, wherein the first plug pin is capable of switching into the plug pin of the American type plug or the Australian type plug.

8. The safety easily operable universal adaptor as claimed in claim 3, wherein the second plug pin is United Kingdom type plug.

9. The safety easily operable universal adaptor as claimed in claim 3, wherein the third plug pin is Europe type plug.
